(19) United States
(12) Patent Application Publication
(10) Pub. No.: US 2021/0203014 A1
(43) Pub. Date: Jul. 1, 2021

(54) BATTERY MANAGER

(71) Applicant: SZ DJI TECHNOLOGY CO., LTD., Shenzhen (CN)

(72) Inventor: Liang LIANG, Shenzhen (CN)

(21) Appl. No.: 17/200,739

(22) Filed: Mar. 12, 2021

Related U.S. Application Data
(63) Continuation of application No. PCT/CN2018/108042, filed on Sep. 27, 2018.

(51) Int. Cl. H01M 10/44; H01M 10/42; H01M 10/48; H01M 10/46; H02J 7/00

(52) U.S. Cl. CPC H01M 10/448; H01M 10/4257; H01M 2010/4271; H01M 10/46; H02J 7/007182; H01M 10/488

(57) ABSTRACT

The present disclosure provides a battery manager for managing power of a battery. The battery manager includes a power display device configured to display a current power level of the battery; a charging circuit configured to charge the battery; an operation input device configured to receive a user input signal and generate a trigger signal; a switch circuit connected to the operation input device; and a controller connected to the switch circuit, the power display device, and the charging circuit. When the operation input device generates the trigger signal to the switch circuit, the switch circuit connects the battery and the controller, the controller controls the switch circuit to maintain a connected state to avoid the switch circuit from being affected by the operation input device. Further, the controller controls displaying the current power level of the battery or charging the battery.

### CROSS-REFERENCE TO RELATED APPLICATION

This application is a continuation of International Application No. PCT/CN2018/108042, filed on Sep. 27, 2018, the entire content of which is incorporated herein by reference.

### TECHNICAL FIELD

The present disclosure relates to the technical field of control technology and, more specifically, to a battery manager.

### BACKGROUND

A battery manager is a device that provides power management for one or a plurality of batteries. When there is an external power supply, the battery manager can charge or manage power for one or more batteries, thereby ensuring that each battery can continuously and reliably supply power. When there is no external power supply, the battery manager can be powered by one or more batteries it manages, and manage the power of each battery based on a set strategy.

However, if the battery is placed in the batter manager for a long time and there is no external power supply, the battery manager will continue to consume battery power, such as the power consumed by the battery manager during operation and standby. In this case, the battery manager will continue to consume or even exhaust the battery power, thereby impair battery power utilization.

### SUMMARY

One aspect of the present disclosure provides a battery manager for managing power of a battery. The batter manager includes a power display device configured to display a current power level of the battery; a charging circuit configured to charge the battery; an operation input device configured to receive a user input signal and generate a trigger signal; a switch circuit connected to the operation input device; and a controller connected to the switch circuit, the power display device, and the charging circuit. The controller is connected to the battery through the switch circuit for the battery to supply power to the controller through the switch circuit. The controller is connected to an external power source for the controller to receive power from the external power source. The controller is configured to obtain the current power level of the battery and control the power display device to display the current power level of the battery. The controller is configured to control the charging circuit to charge the battery. The controller is configured to control the switch circuit to connect or disconnect the battery and the controller. In response to the operation input device generating the trigger signal to the switch circuit, the switch circuit connects the battery and the controller, the battery supplies power to the controller, the controller controls the switch circuit to maintain a connected state to avoid the switch circuit from being affected by the operation input device. In response to the switch circuit connecting the battery and the controller, the controller performs power management on the battery, the power management including one or more of displaying the current power level of the battery or charging the battery.

Another aspect of the present disclosure provides a battery manager for managing power of a battery. The battery manager includes an operation input device configured to receive a user input signal and generate a trigger signal; a switch circuit connected to the operation input device; and a controller connected to the switch circuit. The controller is connected to the battery through the switch circuit for the battery to supply power to the controller through the switch circuit. In response to the switch circuit connecting the battery and the controller, the controller performs power management on the battery. In response to the switch circuit disconnecting the battery and the controller, the controller stops receiving power from the battery. The controller is configured to connect to an external power source for the controller to receive power from the external power source.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a block diagram of a battery manager according to an embodiment of the present disclosure.

FIG. 2 is a block diagram of another battery manager according to an embodiment of the present disclosure.

FIG. 3 is a block diagram of another battery manager according to an embodiment of the present disclosure.

FIG. 4 is a block diagram of another battery manager according to an embodiment of the present disclosure.

FIG. 5A to FIG. 5C are schematic diagrams of a user interaction according to an embodiment of the present disclosure.

FIG. 6 is a block diagram of another battery manager according to an embodiment of the present disclosure.

FIG. 7 is a block diagram of another battery manager according to an embodiment of the present disclosure.

FIG. 8 is a block diagram of a switch circuit according to another embodiment of the present disclosure.

FIG. 9 is a circuit diagram of the switch circuit according to an embodiment of the present disclosure.

FIG. 10 is a block diagram of the battery manager according to an embodiment of the present disclosure.

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

A battery manager can be a device that provides power management for a plurality of batteries. When there is an external power supply, the battery manager can charge or manage power for each battery, thereby ensuring that each battery can continuously and reliably supply power. When there is no external power supply, the battery manager can be powered by each battery it manages, and manage the power of each battery based on a set strategy.

Embodiments of the present disclosure provides a battery control device, such as a battery manager, a charger, an unmanned aerial vehicle (UAV), a gimbal, etc., which can be used for power management of batteries that have been inserted therein.

In one embodiment, the battery control device may include a switch circuit and a controller, and the battery or other external power source carried by the battery control device can be selected to supply power to the controller through the switch circuit.

In one embodiment, the battery control device may include a switch circuit and a controller. The electrical connection between the battery and the controller can be connected or disconnected through the switch circuit. When the switch circuit disconnects the electrical connection between the battery and the controller, the controller may no longer receive power from the battery. When the switch circuit connects the electrical connection between the battery and the controller, the controller may perform power management on the battery.

In one embodiment, the battery control device may include an operation input device, a switch circuit, and a controller. The operation input device may receive the user's input signal and generate a trigger signal to the switch circuit, such that the switch circuit may connect the electrical connection between the battery and the controller. After the controller is powered by the battery, the controller may control the switch circuit to maintain the connected state, such that the switch circuit may no longer be affected by the operation input device, and may perform power management on the battery.

The embodiments of the present disclosure will be described in detail below with reference to the accompanying drawings by taking the battery manger as an example. In the case where there is no conflict between the exemplary embodiments, the features of the following embodiments and examples may be combined with each other.

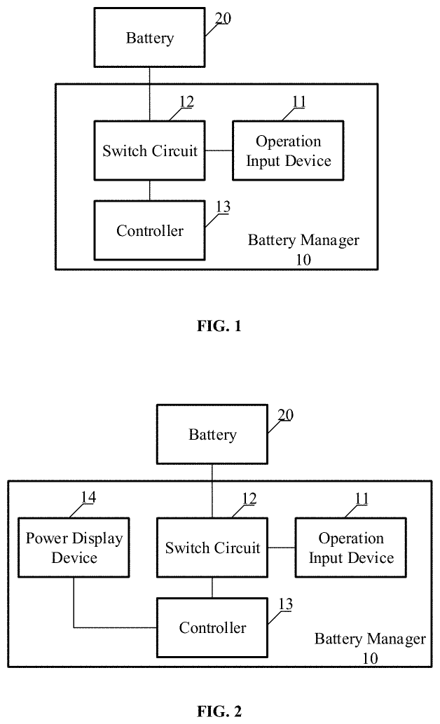

FIG. 1 is a block diagram of a battery manager according to an embodiment of the present disclosure. As shown in FIG. 1, a battery manager 10 of an embodiment of the present disclosure includes an operation input device 11, a switch circuit 12, and a controller 13.

The operation input device 11 may be used to receive the user's input signal and generate a trigger signal. The switch circuit 12 may be electrically connected to the operation input device 11. The controller 13 may be electrically connected to the switch circuit 12. The controller 13 may be electrically connected to a battery 20 through the switch circuit 12 such that the battery 20 can supply power to the controller 13 through the switch circuit 12.

When the switch circuit 12 disconnects the electrical connection between the battery 20 and the controller 13, the controller 13 may no longer receive power from the battery 20. The controller 13 may control the switch circuit 12 to connect to disconnect the electrical connection between the battery 20 and the controller 13. The controller 13 may also be electrically connected to an external power source (not shown in FIG. 1), such that the controller 13 can be powered by the external power source.

When the operation input device 11 generates a trigger signal to the switch circuit 12, the switch circuit 12 may connect the electrical connection between the battery 20 and the controller 13, and the battery 20 may start to supply power to the switch circuit 12. The controller may start to work and control the switch circuit 12 to maintain the connected state, such that the switch circuit 12 is no longer affected by the operation input device 11. When the switch circuit 12 connects the electrical connection between the battery 20 and the controller 13, the controller 13 may perform power management on the battery 20.

It should be noted that the battery manager provided in this embodiment may also have exceptions. That is, when the switch circuit 12 is in a connected state, the connected state of the switch circuit 12 may also be affected by the operation input device 11.

More specifically, when the input duration of the input signal is greater than a predetermined duration, the switch circuit 12 may connect the electrical connection between the battery 20 and the controller 13, and the controller 13 may perform power management on the battery 20. When the operation input device 11 no longer receives an input signal, the operation input device 11 may not generate a trigger signal to the switch circuit 12, and the switch circuit 12 may disconnect the electrical connection between the battery 20 and the controller 13.

It can be understood that the predetermined duration can be customized by the user in advance. In some embodiments, when the controller 13 is powered by an external power source 30, the controller 13 may determine the input duration. For example, when the input duration is greater than the predetermined duration, the switch circuit 12 may connect the electrical connection between the battery 20 and the controller 13.

It should be noted that the action duration of the trigger signal may need to be greater than an initialization duration of the controller 13, thereby ensuring that the controller 13 can start normally.

In some embodiments, the power management may include one or more of displaying the current power level of the battery 20, charging the battery 20, discharging the battery 20, and performing power balance on a plurality of batteries 20.

In this embodiment, take the display of the current power level of the battery 20 as an example, the controller 13 may obtain the power of the battery 20. Subsequently, the controller 13 may perform the following processing based on the specific scenario.

Based on the embodiment shown in FIG. 1, the battery manager 10 may further include a power display device 14. Referring to FIG. 2, the power display device 14 can be electrically connected to the controller 13 and powered by the controller 13. Alternatively, the power display device 14 can be electrically connected to the controller 13 and the battery 20. The battery 20 can supply power to the power display device 14, and the controller 13 can query the current power level of the battery 20. The controller 13 may send the current power level to the power display device 14 via the electrical connection with the power display device 14, and then the power display device 14 may output an indication signal for displaying the current power level of the battery 20. Considering that the power display device 14 may also consume power, therefore, the power display device 14 in this embodiment may start and display only when it receives the control instruction or the current power level sent by the controller 13, then the display may stop after the predetermined duration.

In some embodiments, the power display device 14 may include one or more of an LED, a display, or a speaker.

In some embodiments, the indication signal can include one or more of a visual signal or an audio signal. For example, the visual signal can include light with any time pattern, and can also include one or more of numbers, text, or patterns. The audio signal can be heard by the user and can include sound with any time pattern.

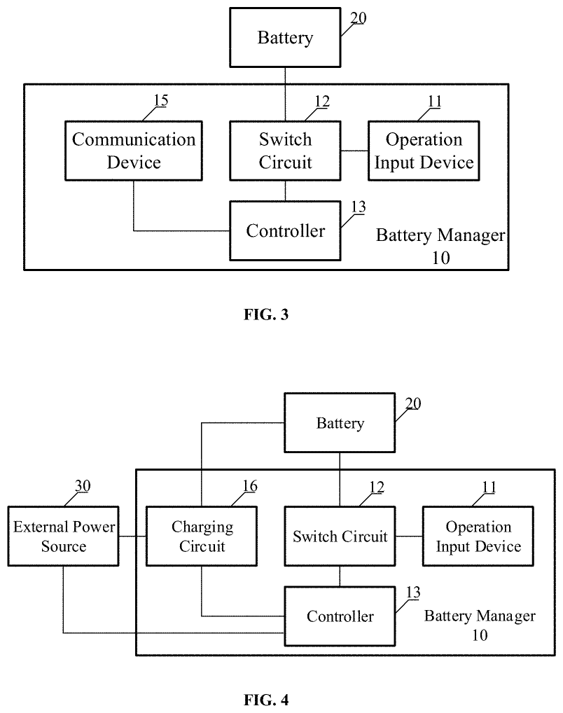

Based on the embodiment shown in FIG. 1, the battery manager may further include a communication device 15. As shown in FIG. 3, the communication device 15 can be electrically connected to the controller 13, such that the controller 13 can send the current power level to the communication device 15, and then the communication device 15 can send the current power level to an opposite communication device (not shown in FIG. 3). More specifically, the communication device 15 may be a Bluetooth module, a network card, or the like. The opposite communication device may be set on a mobile device, such as a personal computer, a tablet, or a handheld device. In this way, the user can check the current power level of the battery 20 on the mobile device where the communication device of the opposite end is positioned, and/or the user can decide whether to continue perform power management on the battery. Considering that the communication device 15 also consumes power, the communication device 15 in this embodiment can start the communication function only when it receives the control instruction or the current power level sent by the controller 13, and the communication device 15 can stop working after the current power level transmission is completed.

Based on the embodiment shown in FIG. 1, the battery manager may further includes a charging circuit 16. In this embodiment, charging the battery 20 is taken as an example. Referring to FIG. 4, the controller 13 can control the charging circuit 16 to turn on the external power source 30 and the battery 20, and the external power source 30 can charge the battery 20. It can be understood that the battery 20 can also supply power to the controller 13.

In some embodiments, the charging circuit 16 may be electrically connected to the external power source 30, the battery 20, and the controller 13 respectively.

For example, the external power source 30 may be a battery with a relatively large capacity. In this case, the charging circuit 16 may be an electronic circuit with DC-DC and DC-AC-DC conversion function. The external power source 30 may also be an AC power grid, such as a power frequency power grid. In this case, the charging circuit may be an electronic circuit with an AC-DC conversion function. For the specific implementation of the electronic circuit, reference may be made to the circuit in the related art, which will not be repeated here.

In some embodiments, the controller 13 may also control the charging circuit 16 to discharge the battery 20. The discharging method may include one or more of power consumption, inversion to the AC grid, conversion to other batteries, etc. In this way, the power of the battery 20 can be maintained in a stable state, which is beneficial to improve the service life of the battery 20.

In some embodiments, the controller 13 may also perform power balance for a plurality of batteries 20. For example, a power range can be predetermined, such as 35% to 90%. When the power of the battery 20 is less than the minimal value of the power range, the power of the battery can be considered to be too low and needs to be charged. When the power of the battery 20 is greater than or equal to the maximum value of the power range, the battery can be considered to be too high and needs to be discharged. The charge or discharge of each battery can be based on the power state of each battery, such that the power of the plurality of batteries can reach a balanced state. In some embodiments, the balanced state may be that the powers in the plurality of batteries are the same, or the powers in the plurality of batteries are all within the power range, which is not limited in the embodiments of the present disclosure.

More specifically, when it is detected that one of the batteries 20 has too much power, the controller 13 may control the charging circuit 16 to connect or disconnect the electrical connection between the battery 20 and the other batteries 20, such that the excessive power in the battery 20 can be transferred to the other batteries. In another example, when it is detected that the power of one battery 20 is too low, the controller 13 may control the charging circuit 16 to connect or disconnect the electrical connection between the battery 20 and the other batteries 20, such that the power in the other batteries can be transferred to the battery 20 with low power. Of course, when the power of one battery is not enough to make the power of the battery with low power reach the power range, another power with too much can be selected, and the newly selected battery can transfer power to the battery with low power.

Based on the embodiment shown in FIG. 2, in some embodiments, other than the controller 13 obtaining the power of the battery 20 and processing it in a predetermined manner, the controller 13 may also pop up a dialog box on the display interface of the power display device 14, and the user may decide whether to continue the power management on the battery, and/or the power display device 14 may receive an input signal input by the user.

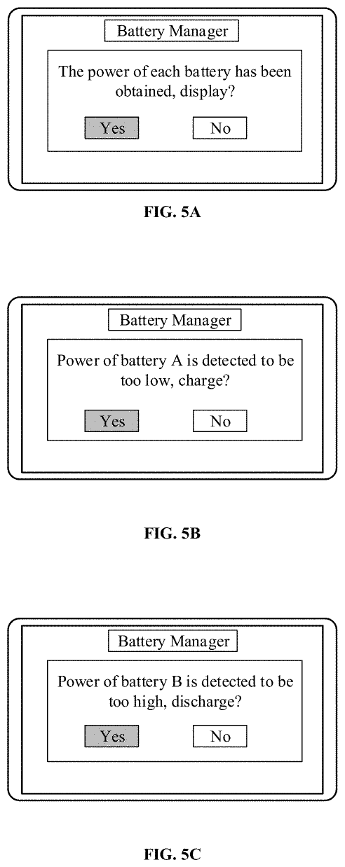

For example, the user may decide whether to display the power of each battery. Referring to FIG. 5A, when the user see the display content of “The power of each battery has been obtained, display?” and the selection buttons “Yes” and “No”, if the button “Yes” is selected, the power of each battery can be directly displayed.

In another example, the user may decide whether to charge the battery. Referring to FIG. 5B, when the user sees the display content of “Power of battery A is detected to be too low, charge?” and the selection buttons “Yes” and “No”, if the button “Yes” is selected, the controller 13 can control the charging circuit 16 to charge the battery A until the power of the battery A is within the power range.

In another example, the user may decide whether to discharge the battery. Referring to FIG. 5C, when the user see the display content of “Power of battery B is detected to be too high, discharge?” and the selection buttons “Yes” and “No”, if the button “Yes” is selected, the controller 13 can control the charging circuit 16 to discharge the battery B until the power of the battery B is within the power range.

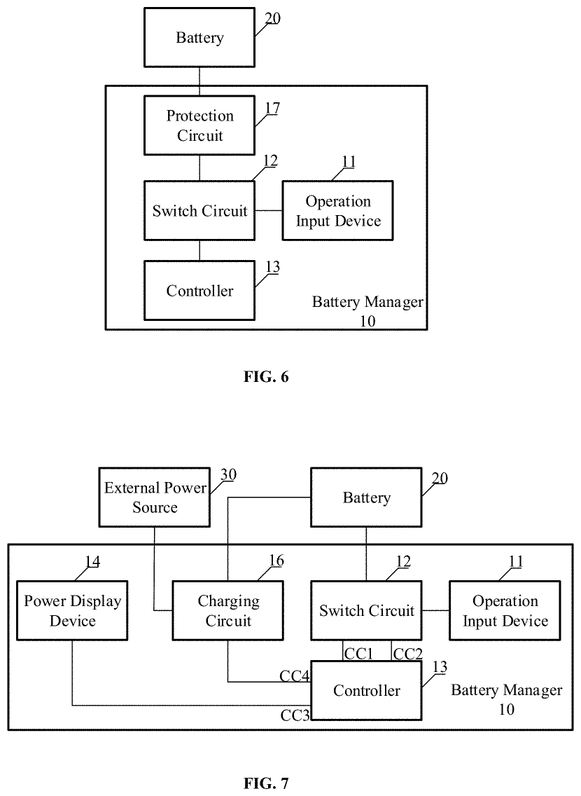

In some embodiments, considering that the controller 13 can be powered by an external power source, if the switch circuit 12 connects the battery 20 and the controller 13, the electrical energy of the external power source may be input to the battery 20. Based on the embodiment shown in FIG. 1, the battery manager may further include a protection circuit 17. Referring to FIG. 6, the protection circuit 17 can be electrically connected between the battery 20 and the switch circuit 12, and configured to prevent current from flowing back into the battery 20 when the external power source provides power to the controller 13, thereby achieving the effect of protecting the battery.

The content shown in FIG. 1 to FIG. 6 describes the connection relationship and signal flow between the various modules in the battery manager. The battery manager can trigger the execute of the power management operation when receiving the user's input information, but will not perform the management function when it is not triggered, which can shorten the working time of the battery manager and reduce the power consumed by the battery manager, such that there is no additional consumption of battery power.

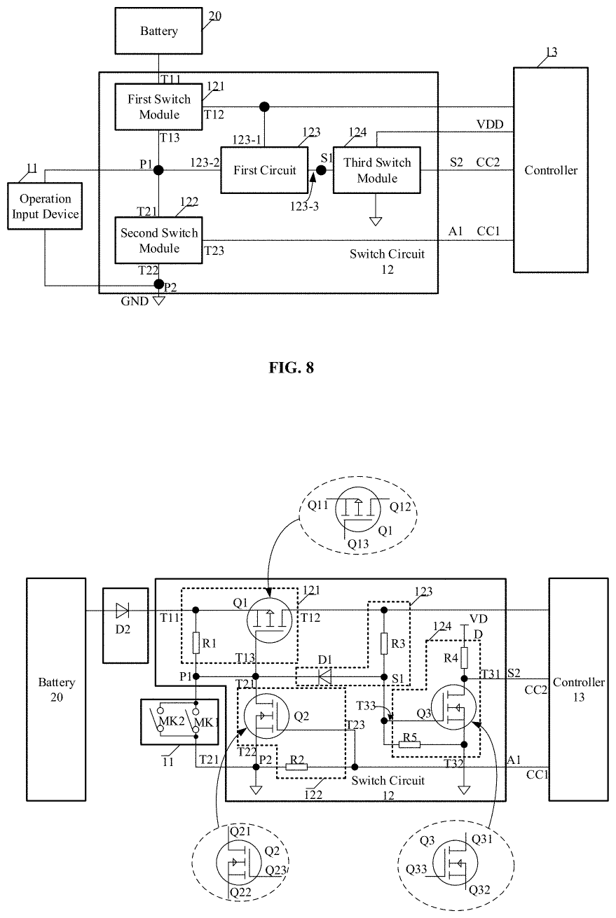

The following describes the additional composition structure and connection relationship of each component in the battery manager with reference with reference to the following embodiments and accompanying drawings. FIG. 7-FIG. 9 and the related embodiments are based on the embodiment shown in FIG. 1.

Referring to FIG. 7, the controller 13 in the battery manager 10 includes a first control terminal CC1. The first control terminal CC1 is electrically connected to the switch circuit 12, and the controller 13 can output a first control signal through the first control terminal CC1, such that the 12 can connect or disconnect the electrical connection between the battery 20 and the controller 13. In some embodiments, the first control signal may be a high-level control signal or a low-level control signal.

In some embodiments, the relationship between the first control signal and the switch circuit 12 may be as follow. When the first control signal is a high-level control signal, the switch circuit 12 can connect the electrical connection between the battery 20 and the controller 13. When the first control signal is a low-level control signal, the switch circuit 12 can disconnect the electrical connection between the battery 20 and the controller 13. Of course, the corresponding relationship between the high and low levels corresponding to the first control signal and the switch circuit 12 can also be interchanged, and the technical solutions of the present disclosure can also be implemented.

It should be noted that the controller 13 in this embodiment may be one of a single-chip microcomputer, DSP, FPGA, or other electronic circuit. Those skilled in the art can configure the controller based on the method in the conventional technology, which is not limited in the embodiments of the present disclosure.

Referring to FIG. 7, the controller 13 further includes a second control terminal CC2. The second control terminal CC2 is electrically connected to the switch circuit 12 for receiving a sensing signal input by the switch circuit 12. In some embodiments, when the second control terminal CC2 obtains the sensing signal, the controller 13 may continuously output the first control signal (i.e., maintain the current high-level or low-level control signal unchanged) to control the connection state between the battery 20 and the controller 13 without being affected by the operation input device 11.

In some embodiments, the sensing signal may be a high-level signal. When the first control signal is a high-level signal, the switch circuit 12 may connect the electrical connection between the battery 20 and the controller 13; and/or, when the switch circuit 12 connects the electrical connection between the battery 20 and the controller 13, the controller 13 may provide a power signal to the switch circuit 12 for the second control terminal CC2 to obtain the sensing signal.

Referring to FIG. 7, the controller 13 further includes a third control terminal CC3. The third control terminal CC3 is electrically connected to the power display device 14, such that when the switch circuit 12 connects the electrical connection between the battery 20 and the external power source 30, the controller 13 can obtain the power of the battery 20. Subsequently, the controller 13 can output a third control signal through the third control terminal CC3 to control the power display device 14 to display the current power level of the battery. In some embodiments, the third control signal may be a high-level control signal, a low-level control signal, a high-level and low-level combined control signal, or the current power level of the battery.

Referring to FIG. 7, the controller 13 further includes a fourth control terminal CC4. The fourth control terminal CC4 is electrically connected to the charging circuit 16, such that when the switch circuit 12 connects the electrical connection between the battery 20 and the 13, the controller 13 can output a fourth control single through the fourth control terminal CC4 to control the charging circuit 16 to charge the battery 20. In this case, the power source of the charging circuit 16 can be an external power source 30, or other batteries 20 with excessive power.

Referring to FIG. 8, the switch circuit 12 in the battery manager 10 includes a first common terminal P1 and a second common terminal P2. The first common terminal P1 is electrically connected to the operation input device 11, and configured to receive a trigger signal of the operation input device 11 to control the switch circuit 12 to connect or disconnect the electrical connection between the battery 20 and the controller 13. The second common terminal P2 is electrically connected to the first common terminal P1 via the operation input device 11.

In some embodiments, when the operation input device 11 is not being operated, the first common terminal P1 may maintain the original potential, and a first switch module 121 may disconnect the electrical connection between the battery 20 and the controller 13. When the operation input device 11 is being operated, the first common terminal P1 and the second common terminal P2 may be directly connected through the operation input device 11, and the potential of the first common terminal P1 may be pulled to the potential of the second common terminal P2. At this time, the first switch module 121 may connect the electrical connection between the battery 20 and the controller 13.

In some embodiments, the second common terminal P2 may be configured as a low-level or a high-level. Take low-level as an example, the configuration method may include the following. The second common terminal P2 may be directly grounded, or the second common terminal P2 may receive a low-level signal, which can be input by the controller 13. Take the high-level as an example, the configuration method may include the following. The second common terminal P2 may be directly connected to the positive of the power supply, or the second common terminal P2 may receive a high-level signal, which can be input by the controller 13.

Referring to FIG. 8, the switch circuit 12 in the battery manager 10 further includes a first signal terminal S1. The first signal terminal S1 is electrically connected to the first common terminal P1 and can output an output signal. The output signal may include one or more of a high-level signal or a low-level signal.

The switch circuit 12 further includes a second signal terminal S2, and the second signal terminal S2 is electrically connected to the controller 13 (via the second control terminal CC2). When the switch circuit 12 connects the electrical connection between the battery 20 and the controller 13, the second signal terminal S2 can be used to output a sensing signal to the controller 13. In some embodiments, the sensing signal can be used to indicate that the switch circuit 12 has connected the battery 20 and the controller 13.

The switch circuit 12 further includes a first signal receiving terminal A1. The first signal receiving terminal A1 is electrically connected to the controller 13 (via the first control terminal CC1), and can be used to obtain the control signal output by the controller 13. The control signal can be used to control the switch circuit 12 to maintain the connected state, such that the switch circuit 12 may not be affected by the operation input device 11. In addition, the control signal can also be used to control the switch circuit 12 to disconnect the electrical connection between the battery 20 and the controller 13.

It can be understood that the foregoing descriptions of FIG. 8 describe several input and output terminals of the switch circuit 12, and the structure and specific circuits of the switch circuit 12 will be described later.

Referring to FIG. 8, the switch circuit 12 includes a first switch module 121. The configuration method of the first switch module 121 may be as follow. When the first switch module 121 is connected, the controller 13 is electrically connected to the battery 20 through the first switch module 121, such that the battery 20 can supply power to the controller 13 and the controller 13 can perform power management on the battery 20.

Referring to FIG. 8, the first switch module 121 includes a first terminal T11, a second terminal T12, and a third terminal T13. The first terminal T11 of the first switch module 121 is electrically connected to the battery 20. The second terminal T12 of the first switch module 121 is electrically connected to the controller 13. The third terminal T13 of the first switch module 121 is electrically connected to the first common terminal P1.

In some embodiments, when the operation input device 11 is triggered, the first common terminal P1 and the first common terminal P1 may be in the connected state, and the potential of the first common terminal P1 may be pulled to the potential of the second common terminal P2, such that the first switch module 121 may be in the connected state, such that the first switch module 121 can connect the battery 20 and the controller 13.

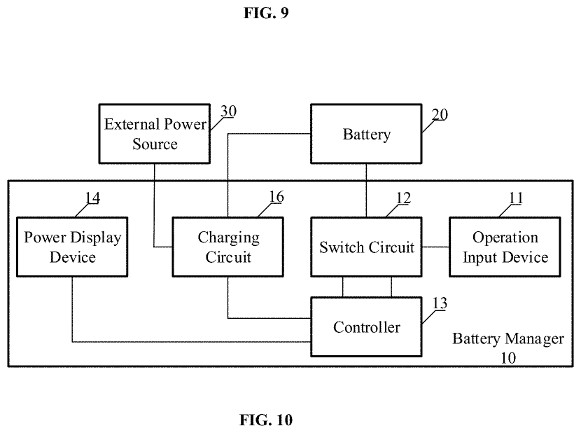

In some embodiments, referring to FIG. 9, the first switch module 121 includes a first electronic switch Q1. The first electronic switch Q1 includes a first pole Q11, a second pole Q12, and a third pole Q13. The first pole Q11 of the first electronic switch Q1 is electrically connected to the first terminal T11 of the first switch module 121. The second pole Q12 of the first switch module 121 is electrically connected to the second terminal T12 of the first switch module 121. The third pole Q13 of the first switch module 121 is electrically connected to the third terminal T13 of the first switch module 121. It can be seen that when the third pole Q13 of the first switch module 121 receives a control signal, the first pole Q11 and the second pole Q12 of the first switch module 121 can be short-circuited, thereby connecting the first terminal T11 and the second terminal T12 or the first switch module 121.

In some embodiments, the first electronic switch Q1 may include one or more of a field effect tube, a solid state relay, a power transistor, or an insulated gate bipolar transistor (IGBT). In some embodiments, the first electronic switch Q1 may be a field effect transistor, such as a P-type field effect transistor.

In some embodiments, referring to FIG. 9, the first switch module 121 further includes a first resistor R1. The first resistor R1 is electrically connected between the first pole Q11 and the third pole Q13 of the first electronic switch Q1 for forming a loop with the first pole Q11 and the third pole Q13 of the first electronic switch Q1. The loop can discharge the charge stored in the parasitic capacitance of the first electronic switch Q1 when the first electronic switch Q1 is off, protect the first electronic switch Q1, and help increase the switching frequency of the first electronic switch Q1.

Referring to FIG. 8, the switch circuit 12 further includes a second switch module 122. The second switch module 122 may be configured to obtain the control signal output by the controller 13 via the first signal receiving terminal A1, and may be in the connected state or the disconnected state based on the control signal. When the second switch module 122 is in the connected state, the switch circuit 12 may connect the electrical connection between the battery 20 and the controller 13.

In some embodiments, when the control signal is a high-level control signal, the second switch module 122 may be in the connected state. Due to the connection of the second switch module 122, the first switch module 121 in the switch circuit 12 can be connected, that is, the switch circuit 12 can connect the electrical connection between the battery 20 and the controller 13.

In some embodiments, when the control signal is a low-level control signal and the operation input device 11 is not generating the trigger signal, the second switch module 122 may be in the disconnected state. At this time, the first switch module 121 in the switch circuit 12 may be disconnected, that is, the switch circuit 12 may disconnect the electrical connection between the battery 20 and the controller 13.

Referring to FIG. 8, the second switch module 122 includes a first terminal T21, a second terminal T22, and a third terminal T23. The first terminal T21 of the second switch module 122 is electrically connected to the first common terminal P1. The second terminal T22 of the second switch module 122 is electrically connected to the second common terminal P2. The third terminal T23 of the second switch module 122 is electrically connected to the first signal receiving terminal A1. The operation input device 11 is electrically connected between the first terminal T21 of the second switch module 122 and the second terminal T22 of the second switch module 122.

In some embodiments, when the third terminal T23 of the second switch module 122 receives the control signal output from the first control terminal CC1 of the controller 13, the first terminal T21 and the second terminal T22 may be shorted-circuited, thereby pulling the potential of the first common terminal P1 to the potential of the second common terminal P2. It can be seen that the process of connecting the second switch module 122 and the process of the operation input device 11 providing an input signal have the same function of triggering the connection of the first switch module 121. Therefore, when the controller 13 continuously inputs the first control signal from the first control terminal CC1 to the third terminal T23, it can be ensured that the switch circuit 12 can connect the connect the electrical connection between the battery 20 and the controller 13, and is no longer being affected by the operation input device 11.

For example, when the control signal is a high-level control signal, the first terminal T21 and the second terminal T22 of the second switch module 122 may be short-circuited, and the second switch module 122 may be in the connected state, thereby controlling the first switch module 121 to be in the connected state, and the switch circuit 12 can connect the electrical connection between the battery 20 and the controller 13.

In some embodiments, when the third terminal T23 of the second switch module 122 receives the control signal output from the first control terminal CC1 of the controller 13, the first terminal T21 and the second terminal T22 may be disconnected. When the operation input device 11 no longer generates a trigger signal, when the controller 13 continuously inputs the first control signal from the first control terminal CC1 to the third terminal T23, the second switch module 122 may disconnect the electrical connection between the battery 20 and the controller 13. For example, when the control signal is a low-level control signal and the operation input device 11 no longer generates a trigger signal, the first terminal T21 and the second terminal T22 of the second switch module 122 may be disconnected. At this time, the second switch module 122 is in the disconnected state, thereby controlling the first switch module 121 to be in the disconnected state, and the switch circuit 12 can disconnect the electrical connection between the battery 20 and the controller 13.

When the switch circuit 12 connects the electrical connection between the battery 20 and the controller 13, the controller 13 may obtain the current power level of the battery 20, and the second switch module 122 may obtain a low-level control signal via the first signal receiving terminal A1. If the operation input device 11 no longer receives an input signal and no longer generates a trigger signal, the switch circuit 12 may be disconnected, and the battery 20 may stop supplying power to the controller 13.

Referring to FIG. 9, the second switch module 122 further includes a second electronic switch Q2. The second electronic switch Q2 includes a first pole Q21, a second pole Q22, and a third pole Q23. The first pole Q21 of the second electronic switch Q2 is electrically connected to the first terminal T21 of the second switch module 122. The second pole Q22 of the second electronic switch Q2 is electrically connected to the second terminal T22 of the second switch module 122. The third pole Q23 of the second electronic switch Q2 is electrically connected to the third terminal T23 of the second switch module 122 for receiving the control signal output by the controller 13. The control signal may include one or more of a high-level control signal or a low-level control signal.

In some embodiments, the second electronic switch Q2 may include one or more of a field effect tube, a solid state relay, a power transistor, or an IGBT. In some embodiments, the second electronic switch Q2 may be a field effect tube, such as an N-type field effect tube.

Take the N-type field effect tube as an example, when the first pole Q21 of the second electronic switch Q2 receives a high-level control signal, the first pole Q21 and the second pole Q22 may be connected, thereby pulling the potential of the first common terminal P1 to the potential of the second common terminal P2. The second electronic switch Q2 may be in the connected state, and the second switch module 122 may be controlled to be in the connected state. Due to the connection of the second switch module 122, the switch circuit 12 may connect the electrical connection between the battery 20 and the controller 13. When the control signal is a low-level control signal and the operation input device 11 no longer generates a trigger signal, the second electronic switch Q2 may be in the disconnected state, the second switch module 122 may be controlled to be in the disconnect state, and the second switch module 122 may disconnect the electrical connection between the battery 20 and the controller 13.

Referring to FIG. 9, the second switch module 122 further includes a second resistor R2. The second resistor R2 is electrically connected between the first pole Q21 and the third pole Q23 for forming a loop with the first pole Q21 and the third pole Q23 of the second electronic switch Q2. The loop can discharge the charge stored in the parasitic capacitance of the second electronic switch Q2 when the second electronic switch Q2 is disconnected, thereby protecting the second electronic switch Q2 and helping to increase the switching frequency of the second electronic switch Q2.

Referring to FIG. 8, the switch circuit 12 further includes a first circuit 123. A first end 123-1 of the first circuit 123 is electrically connected between the switch circuit 12 and the controller 13. A second end 123-2 of the first circuit 123 is electrically connected at the first common terminal P1.

In some embodiments, a third end 123-3 of the first circuit 123 is electrically connected to the first signal terminal S1, and the first signal terminal S1 may be configured to output a low-level control signal when the switch circuit 12 connects the electrical connection between the battery 20 and the controller 13.

Referring to FIG. 4, FIG. 8, and FIG. 9, in some embodiments, when the switch circuit 12 connects the electrical connection between the battery 20 and the controller 13, the first circuit 123 may be in a unidirectional connection state. Or, in the case that the controller 13 fails to receive power from the external power source 30, when the battery 20 supplies power to the controller 13 and the switch circuit 12 disconnects the battery 20 and the controller 13, the first circuit 123 may be in an unpowered state. Or, when the controller 13 is powered by the external power source 30, and the switch circuit 12 disconnects the battery 20 from the controller 13, the first circuit 123 may be in a powered state. For example, when the switch circuit 12 disconnects the electrical connection between the battery 20 and the controller 13, that is, the battery 20 and the controller 13 are in a disconnected state, and the first circuit 123 is in the connected state, the operation input device 11 may receive the user's input signal, and generate a trigger signal to the switch circuit 12, thereby connecting the electrical connection between the battery 20 and the controller 13. It can be understood that when the switch circuit 12 disconnects the electrical connection between the battery 20 and the controller 13, and the controller 13 is not powered by the external power source 30, the first circuit 123 may be in an unpowered state.

Further, the first circuit 123 is electrically connected to the first signal terminal S1, and the first signal terminal S1 may be configured to output a low-level signal when the switch circuit 12 connects the electrical connection between the battery 20 and the controller 13. When the switch circuit 12 disconnects the electrical connection between the battery 20 and the controller 13, the controller 13 receives power from the external power source 30, a high-level signal may be output.

Referring to FIG. 9, the first circuit 123 further includes a third resistor R3. The configuration method of the third resistor R3 may be that when the switch circuit 12 connects the electrical connection between the battery 20 and the controller 13, the potential of the first signal terminal S1 may be pulled down.

In addition, the first circuit may further includes a first diode D1. The anode of the first diode D1 is electrically connected to the third resistor R3, and the cathode of the first diode D1 is electrically connected to the first common terminal P1.

In some embodiments, when the switch circuit 12 connects the electrical connection between the battery 20 and the controller 13, the battery 20 may supply power to the controller 13, and the cathode potential of the first diode D1 can be pulled to the potential at the second common terminal P2. The potential at the anode of the first diode D1 and the potential at the second end of the third resistor R3 may be at the same high level, such that the first diode D1 may be unidirectionally conductive. Since the resistance of the first diode D1 after the connection is negligible, the anode potential of the first diode D1 can be considered to be pulled to the potential of the second common terminal P2. When the battery 20 supplies power to the controller 13 and the switch circuit 12 disconnects the electrical connection between the battery 20 and the controller 13, no current may flow through the first end of the third resistor R3, and the potentials at the anode and the cathode of the first diode D1 may be the same (both are low potentials), such that the first diode D1 and the third resistor R3 may not be energized. When the controller 13 is powered by the external power source 30 and the switch circuit 12 disconnects the battery 20 from the controller 13, current may flow through the third resistor R3, the first end and the second end of the third resistor R3 may have high potentials, and the first circuit 123 may be in the energized state.

Referring to FIG. 8, the switch circuit 12 further includes a third switch module 124. The third switch module 124 may be configured to receive the output signal of the first signal terminal S1 and output a sensing signal at the second signal terminal S2. The sensing signal may include one or more of a high-level signal or a low-level signal.

Referring to FIG. 8, the third switch module 124 further includes a first terminal T31, a second terminal T32, and a third terminal T33. The first terminal T31 of the third switch module 124 is electrically connected to the second signal terminal S2. The second terminal T32 of the third switch module 124 is electrically connected to the second common terminal P2. The third terminal T33 of the third switch module 124 is electrically connected to the first signal terminal S1.

In some embodiments, when the second signal terminal S2 outputs a high-level sensing signal, the first signal receiving terminal A1 can receive the high-level control signal output by the controller 13, and the controller 13 can control the battery 20 and the controller 13 to maintain the connected state without being affected by the operation input device 11.

In some embodiments, when the third switch module 124 receives the output signal of the first signal terminal S1, the third switch module 124 may be controlled to be in the working state. It can be understood that when the third switch module 124 is in the working state, it can receive the output signal of the first signal terminal S1 and output a sensing signal at the second signal terminal S2.

For example, the controller 13 may include a power output terminal VDD. Referring to FIG. 8, the controller 13 can provide a power signal (e.g., a high-level signal) to the switch circuit 12 via the power output terminal VDD for enabling the second control terminal CC2 to obtain the sensing signal.

Referring to FIG. 4, the controller 13 is also electrically connected to an external power source 30. The power output terminal VDD in the controller 13 may be used to electrically connect the external power source 30, such that the power supply state can be maintained. Further third switch module 124 may further include a fourth resistor R4. Referring to FIG. 9, the fourth resistor R4 is electrically connected between the power output terminal VDD and the second control terminal CC2.

When the controller 13 is powered by the external power source 30 and is not powered by the battery, the first signal terminal S1 may output a high-level signal to control the third switch module 124 to be in the working state. When the third switch module 124 is in the working state, the fourth resistor R4 may divide the voltage, and the second signal terminal S2 may obtain a low-level sensing signal. Or, when the controller 13 receives the battery power and the third switch module 124 is in the working state, the fourth resistor R4 may pull the potential of the s2 to a high level, and the second signal terminal S2 may output a high-level sensing signal.

Further, when the first signal terminal S1 outputs a low-level signal, the third switch module 124 may be in the working state, and the second signal terminal S2 may output a high-level sensing signal.

In some embodiments, when the third terminal T33 of the third switch module 124 receives the output signal of the first signal terminal S1, the third switch module 124 may be controlled to be in the working state.

In some embodiments, when the switch circuit 12 connects the electrical connection between the battery 20 and the controller 13, the third switch module 124 may be controlled to be in the working state.

In some embodiments, when the switch circuit 12 connects the electrical connection between the battery 20 and the controller 13, the first signal terminal S1 may output a low-level signal, thereby controlling the third switch module 124 to be in the working state.

When the first signal terminal S1 outputs a low-level signal and the third switch module 124 is in the working state, the second signal terminal S2 may output a high-level sensing signal. At this time, the controller 13 may receive the high-level sensing signal through the second control terminal CC2, and then the controller 13 may respond to the high-level sensing signal through the first control terminal CC1 to output a high-level control signal. Subsequently, the first signal receiving terminal A1 of the switch circuit 12 may be able to receive the high-level control signal output by the first control terminal CC1. As such, the controller 13 may control the battery 20 and the controller 13 to maintain the connected state without being affected by the operation input device 11.

Of course, the controller 13 may also output a low-level control signal through the first control terminal CC1. When the first signal receiving terminal A1 of the switch circuit 12 can receive the low-level control signal output by the first control terminal CC1 and there is no trigger signal, the controller 13 may disconnect electrical connection between the battery 20 and the controller 13, and end the task of battery management.

The third switch module 124 may further include a third electronic switch Q3. Referring to FIG. 9, the third electronic switch Q3 is configured to control the working state of the third switch module 124. When the third electronic switch Q3 is in the disconnected state, the third switch module 124 may be in the working state, and the second signal terminal S2 may output a high-level sensing signal. When the controller 13 receives the high-level sensing signal, the first control terminal CC1 may continuously output a high-level control signal, such that the first switch module 121 and the second switch module 122 may be kept in a connected state, such that the switch circuit 12 can connect the electrical connection between the battery 20 and the controller 13.

In some embodiments, the third electronic switch Q3 may include a first pole Q31, a second pole Q32, and a third pole Q33. Referring to FIG. 9, the first pole Q31 of the third electronic switch Q3 is electrically connected to the first terminal T31 of the third switch module 124. The second pole Q32 of the third electronic switch Q3 is electrically connected to the second terminal T32 of the third switch module 124. The third pole Q33 of the third electronic switch Q3 is electrically connected to the third terminal T33 of the third switch module 124. When the first signal terminal S1 receives a low-level signal, the third pole Q33 of the third electronic switch Q3 may be at a low level, and the third electronic switch Q3 may be in the disconnected state at this time.

In some embodiments, the third switch module 124 may further include a fifth resistor R5. Referring to FIG. 9, the fifth resistor R5 is electrically connected between the second pole Q32 of the third electronic switch Q3 and the third pole Q33 of the third electronic switch Q3, and configured form a loop with the second pole Q32 and the third pole Q33 of the third electronic switch Q3 when the third electronic switch Q3 is in the disconnected state. This loop can discharge the charge stored in the parasitic capacitance of the third electronic switch Q3, and can protect the third electronic switch Q3 and help increase the switching frequency of the third electronic switch Q3.

Referring to FIG. 9, the protection circuit 17 of the battery manager 10 further includes a second diode D2. The anode of the second diode D2 is electrically connect to the battery 20, and the cathode of the second diode D2 can be electrically connected to the switch circuit 12, thereby ensuring that current flows from the battery 20 to the controller 13, preventing the flowing from the controller 13 to the battery 20, and achieving the effect of protecting the battery 20.

Referring to FIG. 9, in this embodiment, the operation input device 11 in the battery manager 10 includes a first input terminal MK1, the input signal includes a first input signal, and the trigger signal includes a first trigger signal. The first input terminal may be configured to receive the first input signal and generate the first trigger signal. In some embodiments, the first trigger signal may be a signal for the controller 13 to obtain the power of the battery 20.

In this embodiment, the operation input device 11 further includes a second input terminal MK2, and the second input terminal MK2 may be another mechanical switch parallel to the mechanical switch MK1. The input signal may include a second input signal, and the trigger signal may include a second trigger signal. The second input terminal may be configured to receive the second input signal and generate the second trigger signal. In some embodiments, the second trigger signal may be a signal from the controller 13 to control the charging circuit to charge the battery. In some embodiments, the operation input device 11 may include one or more of a mechanical switch or a sensor. In this embodiment, the operation input device 11 is a mechanical switch. In some embodiments, the sensor may include one or more of a preheat sensor, a pressure sensor, a touch sensor, a light sensor, an electric sensor, or an audio sensor. It can be understood that the selection of the operation input device can be selected based on the specific scenarios, and the corresponding selection also falls within the protection scope of the present disclosure if the user input signal can be sensed.

Referring to FIG. 9, the first electronic switch Q1 is taken as a P-type field effect tube, the second electronic switch Q2 and the third electronic switch Q3 are taken an N-type field effect tubes, and the second common terminal P2 is grounded as an example to describe the battery manager in this embodiment.

Referring to FIG. 9, after the user operates the mechanical switch MK1, the potential at the first common terminal P1 may be pulled to the potential at the electrical connection (i.e., the ground), and the first electronic switch Q1 may connect the battery 20 and the controller 13. The controller 13 may initiate and perform the power management on the battery 20.

Since the electrical connection between the battery 20 and the controller 13 has been connected, the first signal terminal S1 may output a low-level signal, and the third electronic switch Q3 may be disconnected. At this time, since the controller 13 is powered, the power output terminal VDD may be at a high level, such that the potential at the second signal terminal S2 may be pulled to a high level. In this way, the second control terminal CC2 of the controller 13 may receive the sensing signal output by the second signal terminal S2, and then respond to the high-level sensing signal to control the first control terminal CC1 to continuously output the high-level control signal.

After receiving the high-level control signal, the second electronic switch Q2 may connect the first common terminal P1 and the second common terminal P2. As such, whether the user continue to operate the mechanical switch MK1, the second electronic switch Q2 may maintain the connected state of the first common terminal P1 and the second common terminal P2, such that the switch circuit 12 can maintain the electrical connection between the battery 20 and the controller 13.

In the process of maintaining the electrical connection between the battery 20 and the controller 13, the controller 13 may perform power management on the battery 20.

In the process of maintaining the electrical connection between the battery 20 and the controller 13, the controller 13 may receive the high-level sensing signal output by the second signal terminal S2. After a predetermined period of time, the controller 13 may output a low-level control signal through the first control terminal CC1, and the second electronic switch Q2 may disconnect the electrical connection between the first common terminal P1 and the second common terminal P2. Due to the action of the battery 20 and the first resistor R1, the potential at the first common terminal P1 may be connected to the battery potential. If the mechanical switch MK1 is not operated and there is no trigger signal, the first electronic switch Q1 may be disconnected. The first electronic switch Q1 may disconnect the electrical connection between the battery 20 and the controller 13, and the battery 20 may stop supplying power to the controller 13. Subsequently, if the controller 13 is not powered by the external power source 30, the power output terminal VDD may not be powered, and the second signal terminal S2 may have no sensing signal output. If the controller 13 is powered by the external power source 30, the power output terminal VDD may be powered by the external power source 30, the first circuit 123 may be in the energized state, the first signal terminal S1 may output a high level, the third electronic switch Q3 may be disconnected, the third switch module 124 may be in the working state and control the second signal terminal S2 to output a low-level sensing signal. In this way, the controller 13 may stop the current power level management.

It can be understood that predetermined period of time can be controlled by the controller itself based on the power management method, or can be predetermined by the user.

Take the display of current power level of the battery 20 as an example, the controller 13 may perform other processing based on the specific scenarios.

In some embodiments, after the controller 13 obtains the power of the battery 20, or after the controller 13 obtains the power of the battery 20, and the power display device 14 initiates and displays the current power level of the battery 20, the controller 13 may output a low-level control signal through the first control terminal CC1, such that the second electronic switch Q2 can disconnect the electrical connection between the first common terminal P1 and the second common terminal P2. The first electronic switch Q1 can be disconnected, thereby disconnecting the electrical connection between the battery 20 and the controller 13, and the battery 20 can stop supplying power to the controller 13.

In some embodiments, after the controller 13 obtains the power of the battery 20, or after the controller 13 obtains the power of the battery 20, and the power display device 14 initiates and displays the current power level of the battery 20, after a predetermined period of time, the controller 13 may output a low-level control signal through the first control terminal CC1, such that the second electronic switch Q2 can disconnect the electrical connection between the p1 and the second common terminal P2. The first electronic switch Q1 can be disconnected, thereby disconnecting the electrical connection between the battery 20 and the controller 13, and the battery 20 can stop supplying power to the controller 13.

In some embodiments, when the controller 13 receives the high-level sensing signal output by the second signal terminal S2, after a predetermined period of time, the controller 13 may output a low-level control signal through the first control terminal CC1, such that the second electronic switch Q2 can disconnect the electrical connection between the first common terminal P1 and the second common terminal P2. The first electronic switch Q1 can be disconnected, thereby disconnecting the electrical connection between the battery 20 and the controller 13, and the battery 20 can stop supplying power to the controller 13. It can be understood that within the predetermined period of time, the controller 13 has obtained the power of the battery 20, and the power display device 14 has been initiated and displays the current power level of the battery 20.

It should be noted that in an exception of the embodiments described above, the operation input device 11 may control the switch circuit 12 to be in the connected state or the disconnected state. The operation input device 11 may connect or disconnect the electrical connection between the battery 20 and the controller 13 based on the input duration of the input signal. When the input duration of the input signal is greater than the predetermined duration, the operation input device 11 may generate a trigger signal to trigger the first switch module 121 to connect the electrical connection between the battery 20 and the controller 13. After the controller 13 is powered, the controller 13 may perform the power management on the battery 20. When the operation input device 11 no longer receives input information input by the user, that is, the operation input device 11 no longer generates a trigger signal to the first switch module 121, the first switch module 121 may disconnect the electrical connection between the battery 20 and the controller 13, and the controller 13 may no longer perform power management on the battery 20.

In some embodiments, when the operation input device 11 is triggered, the first common terminal P1 and the second common terminal P2 may be in a connected state, and the potential of the first common terminal P1 may be pulled to the potential of the second common terminal P2, such that the first switch module 121 may be in a connected state. In this way, the first switch module 121 may connect the battery 20 and the controller 13. When the operation input device 11 is not triggered, the first common terminal P1 and the second common terminal P2 may be in a disconnected state, such that the first switch module 121 may be in a disconnected state, such that the first switch module 121 may disconnect the electrical connection between the battery 20 and the controller 13.

More specifically, when the operation input device 11 is triggered, when the potential of the third pole Q13 of the first switch module 121 is pulled to the potential of the second common terminal P2 via the first common terminal P1, the first pole Q11 and the second pole Q12 may be short-circuited, the first electronic switch Q1 may be connected, thereby connecting the first terminal T11 and the second terminal T12 of the first switch module 121. When the operation input device 11 is not triggered, the first electronic switch Q1 may be disconnected, thereby disconnecting the first terminal T11 and the second terminal T12 of the first switch module 121.

The operation input device 11 may also include other input terminals (not shown in the accompanying drawings) for receiving other input signals from the user. For example, an input terminal for receiving a third input signal for disconnecting the switch circuit 12. The operation input device 11 may receive the third input signal input by the user and generate a corresponding trigger signal to the switch circuit 12 for controlling the controller 13 to output a low-level control signal through the first control terminal CC1, thereby disconnecting the electrical connection between the battery 20 and the controller 13.

Referring to FIG. 10, the battery manager of this embodiment of the present disclosure is similar to the battery manager 10 of the foregoing embodiment of the present disclosure. The battery manager includes a power display device 14, a charging circuit 16, an operation input device 11, a switch circuit 12, and a controller 13.

The power display device 14 may be configured to display the current power level of the battery 20. The power display device 14 may indicate the current power level of the battery 20 by outputting an indication signal. The power display device 14 may include one or more of a LED light, a display screen, a speaker, etc. The indication signal may include one or more of a visual signal or an audio signal.

The charging circuit 16 may be configured to charge the battery 20. The charging circuit 16 may be an electronic circuit with DC-DC and DC-AC-DC conversion functions.

The operation input device 11 may be configured to receive input signals from the user and generate a trigger signal. The operation input device 11 may include one or more input terminals. The operation input device 11 may also include one or more of a mechanical switch or a sensor.

The switch circuit 12 may be electrically connected to the operation input device 11. The switch circuit 12 may include one or more of a field effect tube, a solid state relay, a power transistor, or an IGBT, and may also include a resistor and a diode.

The controller 13 may be electrically connected to the switch circuit 12, the power display device 14, and the charging circuit 16. The controller 13 may include one or more of a single-chip microcomputer, a DPS, a FPGA, or other electronic circuits.

In some embodiments, the controller 13 may be electrically connected to the battery 20 through the switch circuit 12, such that the battery 20 can supply power to the controller 13 through the switch circuit 12. When the switch circuit 12 disconnects the electrical connection between the battery 20 and the controller 13, the controller 13 may not receive power from the battery 20.

In some embodiments, the controller 13 may also be electrically connected to the external power source 30, such that the controller 13 can be powered by the external power source 30.

In some embodiments, the controller 13 may be configured to obtain the current power level of the battery 20 and control the power display device 14 to display the current power level of the battery 20.

In some embodiments, the controller 13 may be configured to control the charging circuit 16 to charge the battery 20.

In some embodiments, the controller 13 may be configured to control the switch circuit 12 to connect or disconnect the electrical connection between the battery 20 and the controller 13.

When the operation input device 11 generates a trigger signal to the switch circuit 12, the switch circuit 12 may connect the electrical connection between the battery 20 and the controller 13, and the battery 20 may start to supply power to the controller 13. The controller 13 may start to work and control the switch circuit 12 to maintain the connected state, such that the switch circuit 12 may not be affected by the operation input device 11. When the switch circuit 12 connects the electrical connection between the battery 20 and the controller 13, the controller 13 may perform power management on the battery 20.

In some embodiments, power management may include one or more of charging the battery, displaying the current power level of the battery, discharging the battery, or performing power balance on the battery.

It should be noted that in the present disclosure, relational terms such as first and second, etc., are only used to distinguish an entity or operation from another entity or operation, and do not necessarily imply that there is an actual relationship or order between the entities or operations. The terms “comprising,” “including,” or any other variations are intended to encompass non-exclusive inclusion, such that a process, a method, an apparatus, or a device having a plurality of listed items not only includes these items, but also includes other items that are not listed, or includes items inherent in the process, method, apparatus, or device. Without further limitations, an item modified by a term “comprising a . . . ” does not exclude inclusion of another same item in the process, method, apparatus, or device that includes the item.

The method and apparatus provided in embodiments of the present disclosure have been described in detail above. In the present disclosure, particular examples are used to explain the principle and embodiments of the present disclosure, and the above description of embodiments is merely intended to facilitate understanding the methods in the embodiments of the disclosure and concept thereof; meanwhile, it is apparent to persons skilled in the art that changes can be made to the particular implementation and application scope of the present disclosure based on the concept of the embodiments of the disclosure, in view of the above, the contents of the specification shall not be considered as a limitation to the present disclosure.

What is claimed is:

1. A battery manager for managing power of a battery, comprising:
a power display device configured to display a current power level of the battery;
a charging circuit configured to charge the battery;
an operation input device configured to receive a user input signal and generate a trigger signal;
a switch circuit connected to the operation input device; and
a controller connected to the switch circuit, the power display device, and the charging circuit, wherein
the controller is connected to the battery through the switch circuit for the battery to supply power to the controller through the switch circuit;
the controller is connected to an external power source for the controller to receive power from the external power source;
the controller is configured to obtain the current power level of the battery and control the power display device to display the current power level of the battery;
the controller is configured to control the charging circuit to charge the battery;
the controller is configured to control the switch circuit to connect or disconnect the battery and the controller;
in response to the operation input device generating the trigger signal to the switch circuit, the switch circuit connects the battery and the controller, the battery supplies power to the controller, the controller controls the switch circuit to maintain a connected state to avoid the switch circuit from being affected by the operation input device; and
in response to the switch circuit connecting the battery and the controller, the controller performs power management on the battery, the power management including one or more of displaying the current power level of the battery or charging the battery.

2. The battery manager of claim 1, wherein:
the controller includes a first control terminal, the first control terminal being connected to the switch circuit;
the controller outputs a first control signal through the first control terminal to connect the switch circuit causing the switch circuit to connect or disconnect the battery and the controller.

3. The battery manager of claim 2, wherein:
the controller further includes a second control terminal, the second control terminal being connected to the switch circuit and configured to receive a sensing signal input by the switch circuit; and
in response to the second control terminal obtaining the sensing signal, the controller continuously outputting the first control signal via the first control terminal to control the battery and the controller to maintain the connected state without being affected by the operation input device.

4. The battery manager of claim 3, wherein:
the sensing signal is a high-level signal, and in response to the first control signal being a high-level signal, the switch circuit connecting the battery and the controller; and
in response to the switch circuit connecting the battery and the controller, the controller providing a power signal to the switch circuit for the second control terminal to obtain the sensing signal.

5. The battery manager of claim 1, wherein:
the switch circuit includes a first common terminal, the first common terminal being connected to the operation input device and configured to receive the trigger signal of the operation input device to control the switch circuit to connect or disconnect the battery and the controller;
a second common terminal, the second common terminal being connected to the first common terminal via the operation input device and configured to be a low level or a high level; and
in response to the operation input device being operated, the first common terminal and the second common terminal are directed connected through the operation input device, and a potential of the first common terminal is pulled to a potential of the second common terminal.

6. The battery manager of claim 5, wherein the switch circuit further includes:
a first signal terminal connected to the first common terminal and configured to output an output signal, the output signal including one or more of a high-level signal or a low-level signal;
a second signal terminal connected to the controller and configured to output to a sensing signal when the switch circuit connects the battery and the controller; and
a first signal receiving terminal connected to the controller and configured to obtain a control signal output by the controller, the control signal being used to control the switch circuit being in a disconnected state and control the switch circuit to maintain the connected state to avoid the switch circuit from being affected by the operation input device.

7. The battery manager of claim 5, wherein:
the switch circuit includes a first switch module, the first switch module being configured to connect the battery and the controller when the first switch module is connected, the controller being configured to perform power management on the battery.

8. The battery manager of claim 7, wherein:
the first switch module includes a first terminal, a second terminal, and a third terminal, the first terminal of the first switch module being connected to the battery, the second terminal of the first switch module being connected to the controller, the third terminal of the first switch module being connected the first common terminal; and
in response to the operation input device being triggered, the first common terminal and the second common terminal are connected through the operation input device, and the potential of the first common terminal is pulled to the potential of the second common terminal causing the first switch module to be in the connected state.

9. The battery manager of claim 8, wherein:
the second common terminal is configured to receive the low-level signal.

10. The battery manager of claim 6, wherein:
the switch circuit includes a second switch module, the second switch being configured to obtain the control signal output by the controller via the first signal receiving terminal, and to be in the connected state or the disconnected state based on the control signal; and
the switch circuit connects the battery and the controller when the second switch module is in the connected state.

11. The battery manager of claim 10, wherein
when the control signal is a high-level control signal, the second switch module is in the connected state, and the switch circuit connects the battery and the controller; and
when the control signal is a low-level control signal and the operation input device does not generate the trigger signal, the second switch module is in the disconnected state, and the switch circuit disconnects the battery and the controller.

12. The battery manager of claim 11, wherein:
in response to the switch circuit connecting the battery and the controller, the controller obtains the current power level of the battery; and
the second switch module is configured to obtain the low-level control signal via the first signal receiving terminal, in response to the controller obtaining the current power level of the battery, the battery stops supplying power to the controller if the operation input device does not receive the input signal and does not generate the trigger signal.

13. The battery manager of claim 6, wherein:
the switch circuit further includes a first circuit, a first end of the first circuit being connected between the switch circuit and the controller, and a second end of the first terminal being connected to the first common terminal.

14. The battery manager of claim 13, wherein
when the switch circuit connects the battery and the controller, the first circuit is in a unidirectional connection state; or,
when the controller is powered by the battery, and the switch circuit disconnects the battery from the controller, the first circuit is in an unpowered state; or,
when the controller receives power from the external power source, and the switch circuit disconnects the battery from the controller, the first circuit is in a powered state.

15. The battery manager of claim 6, wherein:
the switch circuit further includes a third switch module, the third switch module being configured to receive the output signal from the first signal terminal, and output the sensing signal at the second signal terminal, the seining signal including one or more of a high-level signal or a low-level signal.

16. The battery manager of claim 1 further comprising:
a protection circuit configured to connect the battery and the switch circuit, and to prevent current from flowing back into the battery when the external power source supplies power to the controller.

17. The battery manager of claim 1, wherein:
the operation input device includes a first input terminal, the input signal includes a first input signal, and the trigger signal includes a first trigger signal;
the first input terminal is configured to receive the first input signal and generate the first trigger signal, the first trigger signal being a signal for the controller to obtain the power of the battery.

18. The battery manager of claim 1, wherein:
the operation input device includes a second input terminal, the input signal includes a second input signal, and the trigger signal includes a second trigger signal;
the second input terminal is configured to receive the second input signal and generate the second trigger signal, the second trigger signal being a signal for the controller to control the charging circuit to charge the battery.

19. The battery manager of claim 1, wherein:
the power display device is connected to the controller and the battery, the controller being configured to obtain the current power level of the battery and control the power display device to display the current power level of the battery.

20. A battery manager for managing power of a battery, comprising:
an operation input device configured to receive a user input signal and generate a trigger signal;
a switch circuit connected to the operation input device; and
a controller connected to the switch circuit, wherein
the controller is connected to the battery through the switch circuit for the battery to supply power to the controller through the switch circuit;
in response to the switch circuit connecting the battery and the controller, the controller performs power management on the battery;
in response to the switch circuit disconnecting the battery and the controller, the controller stops receiving power from the battery; and
the controller is configured to connect to an external power source for the controller to receive power from the external power source.
